(19) United States
(12) Patent Application Publication
(10) Pub. No.: US 2012/0306755 A1
(43) Pub. Date: Dec. 6, 2012

(54) TOUCH KEYBOARD

(75) Inventors: Jaoching LIN, Taipei City (TW); Linabel CHU, Taipei City (TW); Chung-Yi SHEN, New Taipei City (TW); Gary LEE, Taipei City (TW)

(73) Assignee: SENTELIC CORPORATION, Taipei City (TW)

(21) Appl. No.: 13/479,625

(22) Filed: May 24, 2012

(30) Foreign Application Priority Data
Jun. 3, 2011 (TW) 100210164

(51) Int. Cl. G06F 3/041; G06F 3/02

(52) U.S. Cl. 345/168

(57) ABSTRACT

A touch keyboard includes a touch panel that defines a plurality of touch input zones and that has opposite first and second surfaces, and an input member disposed on the first surface of the touch panel. The input member includes a body and a plurality of resilient key units disposed on the body. The resilient key units are separate from each other and protrude respectively from the body at positions corresponding to the touch input zones and are able to contact with the first surface of the touch panel during deformation thereof, respectively.

### CROSS-REFERENCE TO RELATED APPLICATION

This application claims priority to Taiwanese Application No. 100210164, filed on Jun. 3, 2011.

### BACKGROUND OF THE INVENTION

1. Field of the Invention

The invention relates to a keyboard, and more particularly to a touch keyboard.

2. Description of the Related Art

Nowadays, touch keyboards are becoming more and more popular with advancement of touch control related technologies. Compared to mechanical keyboards, touch keyboards are not easily damaged, but there is no touching feedback, resulting in difficulty for users to cognize and memorize the positions of those keys and causing inconveniences in use.

Taiwanese Patent Publication Number M366715 discloses an assembly of a touch panel and a keyboard as shown in FIG. 1. The assembly includes a touch panel 91, a rubber keyboard 92, and a thin film circuit board 93. The touch panel 91 is disposed on the rubber keyboard 92. When a downward pressure is applied on a key of the rubber keyboard 92, the thin film circuit board 93 disposed under the rubber keyboard 92 may conduct to transmit a corresponding key signal to a computer (not shown). On the other hand, if no downward pressure is applied, general touch control signals may be generated. However, such design still has a drawback that no touching feedback to facilitate users in cognizing and memorizing position of keys is provided. This makes it inconvenient to users who feel it difficult to get used to the flat surface of the touch keyboard.

### SUMMARY OF THE INVENTION

Therefore, an object of the present invention is to provide a touch keyboard that can overcome the above drawbacks of the prior art.

According to the present invention, a touch keyboard comprises a touch panel that defines a plurality of touch input zones and that has opposite first and second surfaces, and an input member disposed on the first surface of the touch panel. The input member includes a body and a plurality of resilient key units disposed on the body. The resilient key units are separate from each other and protrude respectively from the body at positions corresponding to the touch input zones and are able to contact with the corresponding touch input zones of the touch panel during deformation thereof, respectively.

### BRIEF DESCRIPTION OF THE DRAWINGS

FIG. 1 illustrates a conventional assembly of a touch panel;

FIG. 2 illustrates a first preferred embodiment of a touch keyboard according to the present invention;

FIG. 3 illustrates a modification of the first preferred embodiment;

FIG. 4 is a schematic perspective view showing a display member of the first preferred embodiment;

FIG. 5 is a schematic diagram showing a touch panel of the first preferred embodiment;

FIG. 6 is a schematic perspective view showing an input member of the first preferred embodiment;

FIG. 7 illustrates a modification of the input member of the first preferred embodiment;

FIG. 8 illustrates a second preferred embodiment of a touch keyboard according to present invention;

FIG. 9 is a schematic perspective view showing an input member of the second preferred embodiment; and

FIG. 10 is a schematic diagram showing a modification of the touch panel of the preferred embodiments.

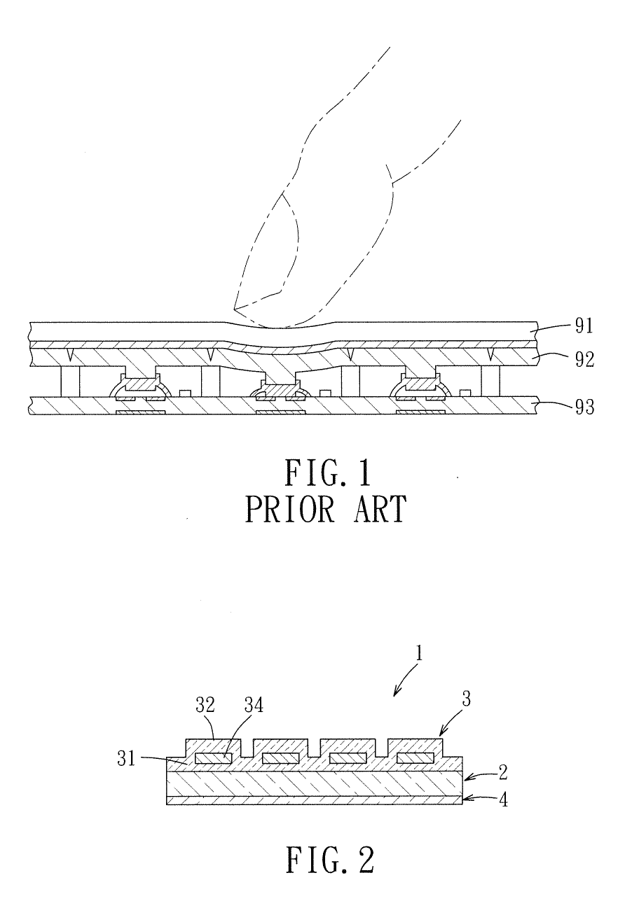

### DETAILED DESCRIPTION OF THE PREFERRED EMBODIMENTS

Before the present invention is described in greater detail with reference to the preferred embodiments, it should be noted herein that similar components are denoted by the same reference numerals in the following description.

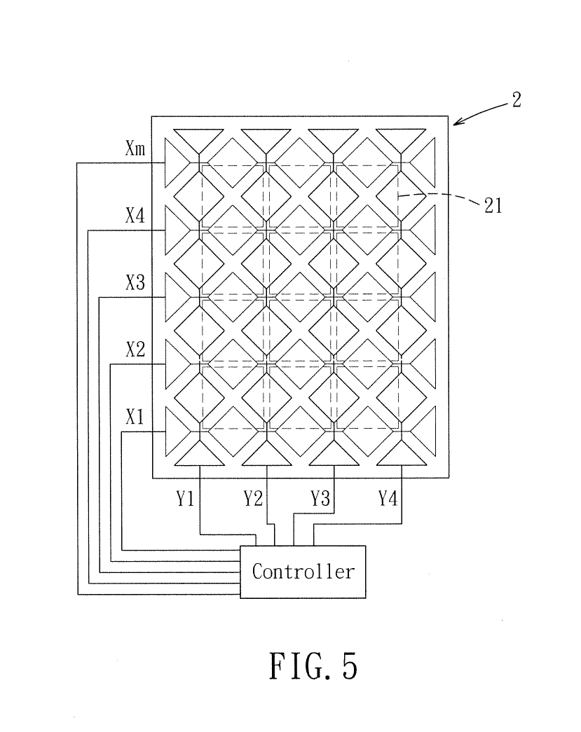

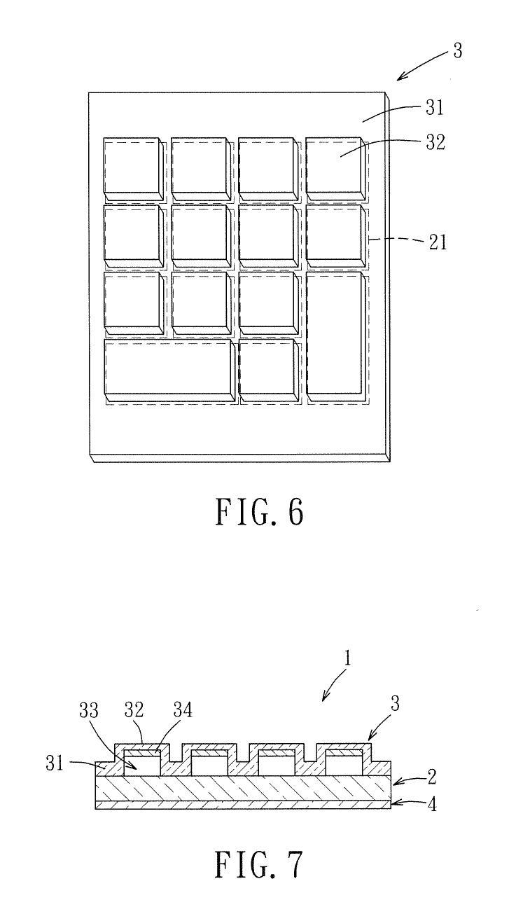

Referring to FIG. 2 to FIG. 6, a touch keyboard 1 of a first preferred embodiment according to the present invention comprises a touch panel 2 that defines a plurality of touch input zones 21 and has opposite first and second surfaces, and an input member 3 disposed on the first surface of the touch panel 2. The input member 3 includes a body 31 and a plurality of resilient key units 32 disposed on the body 31. The resilient key units 32 are separate from each other and protrude respectively from the body 31 at positions corresponding to the touch input zones 21 and are able to contact with corresponding touch input zones 21 of the touch panel 2 during deformation thereof, respectively.

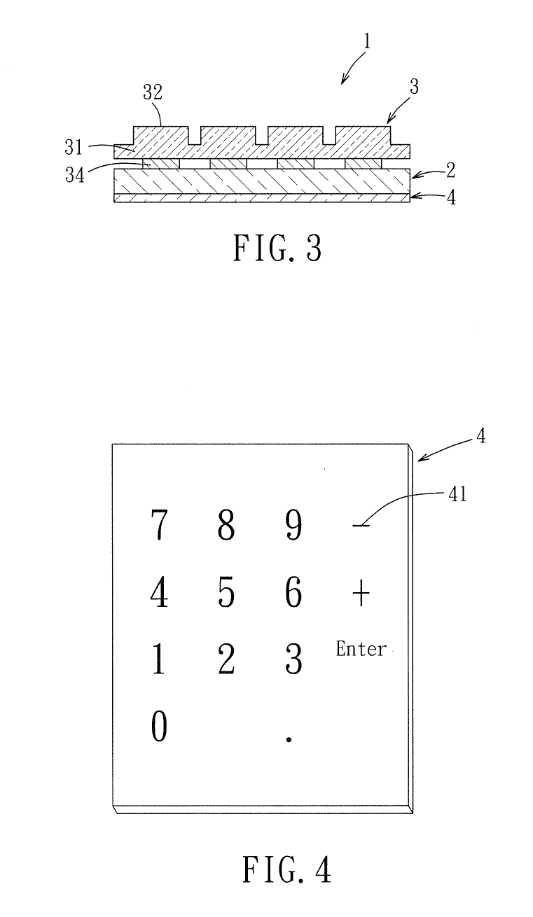

In this embodiment, the touch panel 2 is transparent. The touch keyboard 1 further includes a display member 4 (such as a flat LCD panel) and is electrically coupled to an external computer device (not shown). The display member 4 is disposed on the second surface of the touch panel 2 and serves to display visual information, for example, a plurality of visible marks 41 at positions respectively corresponding to the touch input zones 21. In other words, the display member 4 could be responsive to an input mode from an external computer device to display different visible marks 41 corresponding to input commands of the touch input zones 21 according to different definitions of the touch input zones 21, such as American keyboard definition, European keyboard definition, a game keyboard definition, etc. The input member 3 is disposed detachably on the first surface of the touch panel 2 and is made of a transparent and resilient material. Therefore, users can change to a suitable input member 3 corresponding to definition of the touch input zones 21 in a desired input mode. In order to enhance the effect of electrical coupling between the input member 3 and the touch panel 2 for increasing input sensitivity of the resilient key units 32, the resilient input member 3 could include a plurality of conductors 34, which are composed of Indium Tin Oxide (ITO) or other transparent conductors, and each of the conductors 34 is embedded in a respective one of the resilient key units 32 as shown in FIG. 2. Size of each of the conductors 34 is not larger than size of the corresponding resilient key unit 32. Alternatively, as shown in FIG. 3, the conductors 34 could be disposed respectively on the touch panel 2 at positions corresponding to the touch input zones 21.

In this embodiment, when the user desires to input a command through the touch keyboard 1, the display member 4 would be configured to display the visible marks 41 and the touch input zones 21 would be defined on the touch panel 2 according to the input mode from the external computer device. Afterwards, a transparent input member 3 that corresponds to the input mode is to be disposed on the first surface of the touch panel 2, resulting in the visible marks 41 displayed on the display member 4 to be visible through the input member 3 so that the user could input commands accordingly. Because the input member 3 is made of a resilient material, which includes but not limited to silicone or rubber, when the user types on the resilient key units 21 of the input member 3, feedbacks could be obtained through the bounce of the resilient key units 32. Such advantage not only facilitates cognizing and memorizing positions of the resilient key units 32 through touching feedback to increase typing speed, but also provides softer bounce that may ease a strike between user's finger and the surface of the touch keyboard, thereby prevent injury to user's hands after long hours of typing. Besides, since the simple structure of the input member 3 makes it possible to manufacture the same at a lower cost, several input members 3 could be prepared for use with different touch input zones 21 defined in different input modes, thereby expanding usage of the touch panel 2.

Referring to FIG. 7, each of the resilient key units 32 could be formed with a cavity 33 opposite to the touch panel 2 in order to enhance deformability, such that when the resilient key units 32 are pressed, fingers would sink in more easily to result in a more evident touching feedback.

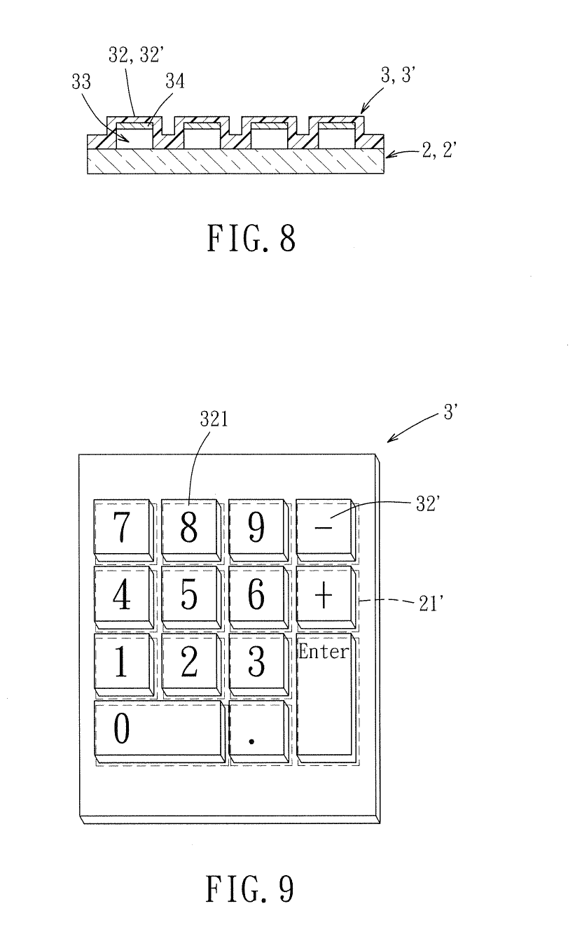

Additionally, the input member 3 could include a plurality of conductors 34 in order to enhance sensitivity of capacitive coupling between the touch panel 2 and fingers. Each of the conductors 34 is disposed on an inner surface of the cavity 33 of each resilient key unit 32 that is opposite to the touch panel 2, as shown in FIG. 8.

FIG. 8 and FIG. 9 show a touch keyboard of a second preferred embodiment according to the present invention. The difference between the second preferred embodiment and the first preferred embodiment resides in that the touch panel 2′ is a capacitive touch panel manufactured using a printed circuit board. The touch panel 2′ defines a plurality of fixed touch input zones 21′. The input member 3 is made of an opaque and resilient material, and is disposed detachably on the first surface of the touch panel 2′. Each of the resilient key units 32′ has a visible mark 321 corresponding to each of the touch input zones 21′ on a surface thereof. The touch keyboard of this embodiment can serve as an independent touch keyboard, such as a numeric keyboard or a game keyboard, or as an input keyboard in a notebook computer. While the touch panel 2′ is made of an opaque material, the visible marks 321 on the resilient key units 32′ of the input member 3′ make it possible for users to press the resilient key units 32′ for triggering the touch input zones 21′ to output key signals, and the touching feedback is likewise achieved when typing on the resilient key units 32′. Similar to the first preferred embodiment, users could change to a suitable input member 3′ for use with touch input zones 21′ defined in a desired input mode.

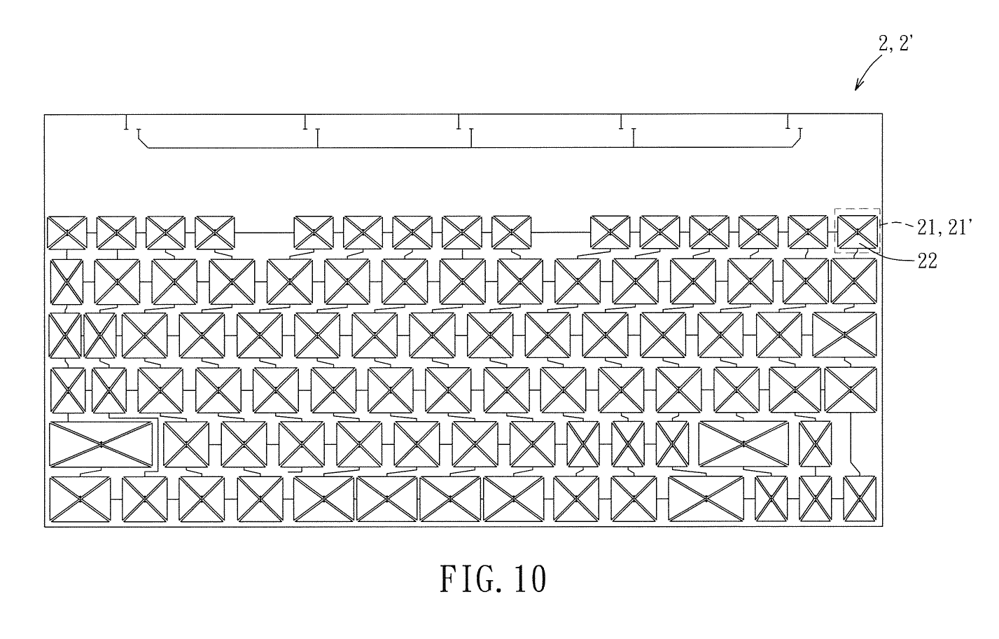

Moreover, the touch panel 2 or 2′ could be designed as shown in FIG. 10. The touch panel 2 or 2′ defines a plurality of touch input zones 21 or 21′ corresponding to a plurality of the resilient key units 32 or 32′ of the input member 3 or 3′. The touch panel 2 or 2′ has one sensing unit 22 disposed at each of the touch input zones 21 or 21′. When one of the resilient key units 32 or 32′ of the input member 3 or 3′ is pressed, the sensing unit 22 of a corresponding one of the touch input zones 21 or 21′ will sense a touch signal and transmit a corresponding key signal to the external computer device via a controller (not shown). Such design of the sensing unit 22 of the touch panel 2 or 2′ could reduce the number of scan lines and enhance sensitivity when pressing keys.

To sum up, the input member 3 or 3′ not only has advantages of providing touching feedback and preventing hands from injury attributed to typing directly on the touch panel 2 or 2′, but also enables design of different input members 3 or 3′ according to user's demand or predetermined input mode. Therefore, a transparent input member 3 could be used detachably with the touch panel 2 that has a display member 4, while an opaque input member 3′ could be used with the touch panel 2′ which is manufactured using a printed circuit board.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A touch keyboard comprising:
a touch panel that defines a plurality of touch input zones and that has opposite first and second surfaces; and
an input member disposed on said first surface of said touch panel, said input member including a body and a plurality of resilient key units disposed on said body, said resilient key units being separate from each other and protruding respectively from said body at positions corresponding to said touch input zones.

2. The touch keyboard as claimed in claim 1, wherein each of said resilient key units is formed with a cavity that is opposite to said touch panel.

3. The touch keyboard as claimed in claim 2, wherein said input member further includes a plurality of conductors, each disposed on an inner surface of the cavity of each resilient key unit that is opposite to the touch panel.

4. The touch keyboard as claimed in claim 1, further comprising a plurality of conductors disposed respectively on said touch panel at positions corresponding to said touch input zones.

5. The touch keyboard as claimed in claim 1, wherein said input member further includes a plurality of conductors, each conductor embedded in a respective one of said resilient key units.

6. The touch keyboard as claimed in claim 1, wherein each of said touch input zones of said touch panel has a visible mark, and said input member is made of a transparent material.

7. The touch keyboard as claimed in claim 1, wherein each of said resilient key units has a visible mark on a surface thereof.

8. The touch keyboard as claimed in claim 1, further comprising a display member disposed on said second surface of said touch panel, each of said touch panel and said input member being transparent, said display member having a plurality of visible marks at positions respectively corresponding to said touch input zones and visible through said touch panel and said input member.

9. The touch keyboard as claimed in claim 8, wherein said display member is responsive to control from an external computer device to display said visible marks thereon.

10. The touch keyboard as claimed in claim 1, wherein said input member is disposed detachably on said first surface of said touch panel.

11. The touch keyboard as claimed in claim 1, wherein said touch panel includes a plurality of touch sensing units disposed respectively at positions corresponding to said touch input zones.

12. An input member for use with a touch panel that defines a plurality of touch input zones, said input member comprising a body and a plurality of resilient key units disposed on said body, said resilient key units being separate from each other and protruding respectively from said body at positions corresponding to the touch input zones.

13. The input member as claimed in claim 12, wherein each of said resilient key units is formed with a cavity.

14. The input member as claimed in claim 13, further comprising a plurality of conductors, each disposed on an inner surface of the cavity of each resilient key unit that is opposite to the touch panel.

15. The input member as claimed in claim 12, further comprising a plurality of conductors, each conductor being embedded in a respective one of said resilient key units.

16. The input member as claimed in claim 12, which is made of a transparent material.

17. The input member as claimed in claim 12, which is made of silicone or rubber.

18. The input member as claimed in claim 12, wherein each of said resilient key units has a visible mark on a surface thereof.
